(19) United States
(12) Patent Application Publication
(10) Pub. No.: US 2026/0083264 A1
(43) Pub. Date: Mar. 26, 2026

(54) UTENSIL

(71) Applicant: humangear, Inc., San Francisco, CA (US)

(72) Inventors: Christopher A. MIKSOVSKY, Boulder, CO (US); Scott D. COOK, Oakland, CA (US)

(21) Appl. No.: 19/299,118

(22) Filed: Aug. 13, 2025

Related U.S. Application Data
(60) Provisional application No. 63/698,307, filed on Sep. 24, 2024.

(51) Int. Cl. A47G 21/06; A47G 21/00; A47G 21/02; A47G 21/04; B26B 3/02

(52) U.S. Cl. CPC A47G 21/06; A47G 21/023; A47G 21/04; B26B 3/02; A47G 2021/002

(57) ABSTRACT

A utensil includes first and second utensil components that are releasable coupled together. The releasable coupling rotationally couples a handle segment of the first utensil component to a handle segment of the second handle component such that the utensil components can be rotated relative to one another about a pivot axis between distinct first and second orientations. The releasable coupling is configured such that the utensil components are not releasable when oriented in an extended position and when oriented in the nested or stacked position. However, the utensil components can be separated when they are oriented in a release orientation that is rotationally between the nested/stacked and extended positions. In some embodiments, the utensil further includes a releasable lock that holds the utensil components in the extended position and a catch feature that helps hold the utensil components in the nested/stacked position.

### CROSS-REFERENCE TO RELATED APPLICATIONS

This application claims priority of U.S. Provisional Application No. 63/698,307, filed on Sep. 24, 2024, which is incorporated herein by reference in its entirety.

### BACKGROUND

The present invention relates generally to eating utensils.

Eating utensils are widely used throughout the world. Some utensils are designed to be easily carried for uses such as camping, pack lunches (or other meals), picnics, etc. In order to minimize utensil size for carrying and storage, some utensils combine the functionality of more than one utensil (e.g., a spoon and a fork) into a single utensil that is collapsable in some way. By way of example, U.S. Pat. No. 11,503,933 (Duo) describes one such design. Others include handles that can be collapsed in some way to reduce the overall size of the utensil for storage and/or carrying. By way of example, U.S. Pat. No. 10,857,661 (Click) describes one such design. Although existing utensils work well, there are continuing efforts to develop new utensils that are readily transportable in a compact form and provide improved function and/or convenience in selected settings.

### SUMMARY OF THE INVENTION

In one aspect, a utensil includes first and second utensil components and a releasable coupling. The first utensil component includes a first utensil head and a first handle segment integrally formed with the first utensil head. The second utensil component includes a second handle segment. In some embodiments, the second utensil component further includes a second utensil head integrally formed with the second handle segment. The releasable coupling rotationally couples the first handle segment to the second handle segment such that the first and second handle segments can be rotated relative to one another about a pivot axis between distinct first and second orientations.

In some embodiments, the first and second orientation are nested and extended orientations. In the nested orientation, the first and second utensil heads are nested together with the first and second handle segments aligned longitudinally and stacked. In some embodiments, the first and second orientation are stacked and extended orientations. In the stacked orientation, the first and second handle segments are aligned longitudinally and stacked.

In the extended orientation the first and second handle elements are aligned longitudinally with the first and second utensil heads located on opposite ends of the utensil.

The releasable coupling is configured such that the first and second utensil components are held together and are not releasable when oriented in the extended position and when oriented in the nested or stacked position. The releasable coupling is further configured such that the first and second utensil components can be separated when the first and second utensil components are oriented in a release orientation that is rotationally between the nested/stacked and extended positions, there being at least one such release orientation.

In some embodiments, the utensil further includes a releasable lock and a catch feature. The releasable lock is configured to lock the first and second utensil components in the extended position when the first and second utensil components are oriented in the extended position. The catch feature configured to help hold the first and second utensil components in the nested/stacked position when the first and second utensil components are oriented in the nested/stacked position.

In some embodiments, the release orientation is an orientation in which a longitudinal axis of the first handle segment is substantially perpendicular to a longitudinal axis of the second handle segment.

In some embodiments, the releasable coupling allows the first and second utensil components to be rotated 360 degrees relative to one another about the pivot axis and includes two distinct release orientations. In both of the two distinct release orientations, the longitudinal axis of first handle segment is substantially perpendicular to the longitudinal axis of the second handle segment.

In some embodiments, the lock mechanism includes a cantilever spring integrally formed with the first handle segment of the first utensil component. The cantilever spring including a spring arm and a raised pad. The raised pad is configured to snap into a first recess on the second handle segment when the first and second utensil components are rotated to the extended orientation to help lock the first and second utensil components in the extended orientation. The lock can be released by pressing on the pad and rotating the first and second utensil components relative to one another. In some embodiments, the raised pad is configured to engage a second recess on the second utensil component when the first and second utensil components are in the nested/stacked position to help hold the first and second utensil components in the nested/stacked position. In some embodiments, the catch mechanism is or includes the second recess.

In some embodiments, side walls of the second recess are tapered so that rotation of the first and second utensil components relative to one another about the pivot axis from the nested/stacked position depresses and loads the cantilever spring.

In some embodiments, the first recess has a pair of substantially perpendicular side walls that form stops that help prevent relative rotation between the first and second utensil components when the utensil is locked in the extended position.

In some embodiments, the utensil further includes a spring opening in the first handle segment having opening walls. The cantilevered spring is positioned to be received within the spring opening. The cantilevered spring includes a pair of spring ears extending outward from opposite side edges of the lever arm at or near a free end of the lever arm such that a lateral width of the cantilevered spring between opposite spring ears is wider than a lateral width of the spring arm and wider than a lateral width of the pad, the ears being closely received within the spring opening and configured to limit looseness of the locking mechanism due to lateral flexibility of the spring arm.

In some embodiments, the releasable coupling includes a post on the second handle segment, a post opening in the first handle, and a pair of recessed ledges on the first handle segment adjacent the post opening. The post includes a pair of overhanging lobes. The post opening is configured to tightly receive the post including the lobes when the first and second utensil components are oriented in a release orientations to facilitate attachment and separation of the first and second utensil components. The post lobes are configured to pass on an opposite side of the ledges as a main body portion of the second handle segment as the first and second utensil components are rotated away from the release orientation toward the nested/stacked or extended orientation. With this arrangement, the ledges and the lobes cooperate to prevent the first and second utensil components from separating when the first and second utensil components are not in one of the at least one release orientations.

In some embodiments, the post does not protrude beyond a back surface of the first handle segment when first and second handle components are coupled together via the post. In some embodiments, the post has a central bore structured to receive to facilitate attaching the utensil to an external structure or hanging the utensil on the external structure.

In some embodiments, one of the utensil heads is a spoon head and the other of the utensil heads is a fork head. In some embodiments, the fork head has a fork bowl portion that is configured to nest with a spoon bowl portion of the spoon head. In some such embodiments, in the nested position, the fork head is nested over the spoon head and does not extend outside of a footprint of the spoon head.

In some embodiments, one of the utensil heads is a fork head having a plurality of tines including a pair of outer tines and at least one inner tine, and wherein at least one of the outer tines is a splitter tine having a chamfer that facilitates splitting food. In some embodiments, an edge of an upper surface of the handle segment is chamfered and the fork head chamfer merges with the handle segment chamfer.

In some embodiments, the first utensil head is selected from the group consisting of a spoon head, a fork head, a spork head and a knife head and the second utensil component is a handle extension.

In another aspect, a utensil includes first and second utensil components. The first utensil component includes a first utensil head and a first handle segment integrally formed with the first utensil head. The second utensil component including a second handle segment. A coupling rotationally couples the first handle segment to the second handle segment such that the first and second handle segments can be rotated relative to one another about a pivot axis between distinct stacked and extended orientations. In the stacked orientation, the first and second handle segments are stacked and align longitudinally. In the extended orientation the first and second handle elements are aligned longitudinally and extend in opposite directions relative to the coupling. A releasable lock is provided to lock the first and second utensil components in the extended position when the first and second utensil components are oriented in the extended position. A catch feature is provided to help hold the first and second utensil components in the stacked position when the first and second utensil components are oriented in the stacked position.

In some embodiments, the second utensil component further includes a second utensil head that is integrally formed with the second handle segment. In some embodiments, the first and second utensil heads are selected from the group consisting of a spoon head, a fork head, a spork head and a knife head.

In other embodiments, the first utensil head is selected from the group consisting of a spoon head, a fork head, a spork head and a knife head and the second utensil component is a handle extension.

In yet another aspect, a combination spoon and fork utensil is provided. The utensil includes a fork, a spoon and a releasable coupling. The fork includes a fork head, and a fork handle integrally formed with the fork head. The spoon includes a spoon head and a spoon handle integrally formed with the spoon head. The releasable coupling rotationally couples the fork handle to the spoon handle such that the fork and spoon can be rotated relative to one another about a pivot axis between distinct nested and extended orientations. In the nested orientation, the fork and spoon heads are nested together with the fork and spoon handles aligned longitudinally and stacked. In the extended orientation the fork and spoon handles are aligned longitudinally with the fork and spoon heads located on opposite ends of the utensil. The releasable coupling is configured such that the fork and spoon are held together and are not releasable when oriented in the extended position and when oriented in the nested position. The releasable coupling is further configured such that the fork and spoon can be separated when the fork and spoon are oriented in a release orientation that is rotationally between the nested and extended positions, there being at least one such release orientation.

A releasable lock is provided to lock the fork and spoon in the extended position when the fork and spoon are oriented in the extended position. A catch feature is provided to help hold the fork and spoon in the nested position when the fork and spoon are oriented in the nested position.

### BRIEF DESCRIPTION OF THE DRAWINGS

The invention and the advantages thereof, may best be understood by reference to the following description taken in conjunction with the accompanying drawings in which:

FIG. 1 is a top perspective of a combination spoon and fork in an extended position in accordance with an embodiment.

FIG. 2 is a top perspective of the combination spoon and fork of FIG. 1 in a nested position in accordance with an embodiment.

FIG. 3 is a top perspective view of the spoon of FIG. 1 alone.

FIG. 4 is a bottom view of the spoon of FIG. 1 alone.

FIG. 5 is an enlarged bottom perspective view of the spoon handle highlighting the post and lever opening regions of the spoon handle.

FIG. 6 is a top perspective view of the fork of FIG. 1 alone.

FIG. 7 is a bottom view of the fork of FIG. 1 alone.

FIG. 8 is an enlarged bottom perspective view of the fork handle highlighting the coupling post.

FIG. 9 is partially cut away perspective view of the spoon and fork in a release position.

FIG. 10 is cross-sectional view of the nested orientation taken through a centerline of the releasable coupling.

In the drawings, like reference numerals are sometimes used to designate like structural elements. It should also be appreciated that the depictions in the figures are diagrammatic and not to scale.

### DETAILED DESCRIPTION

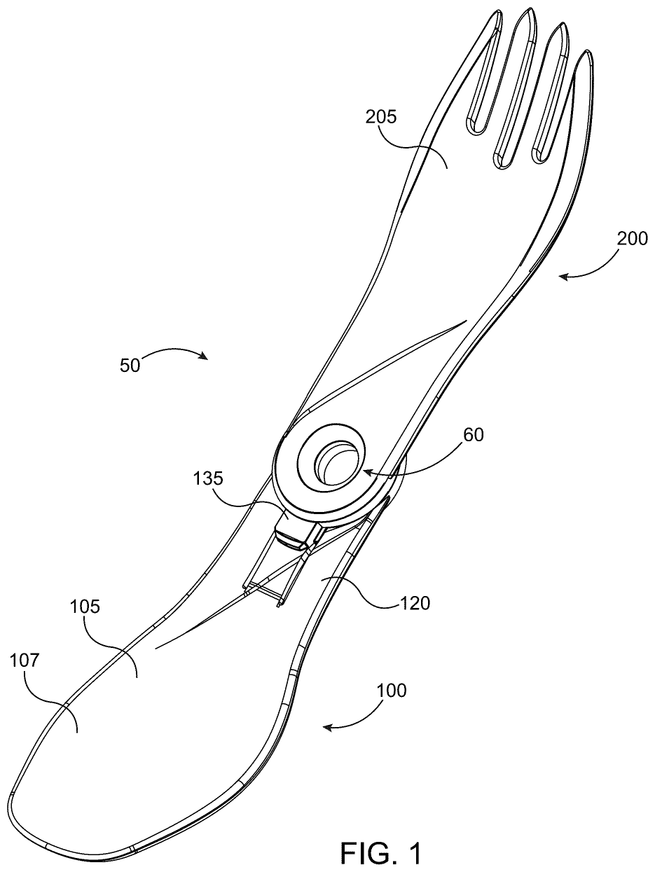

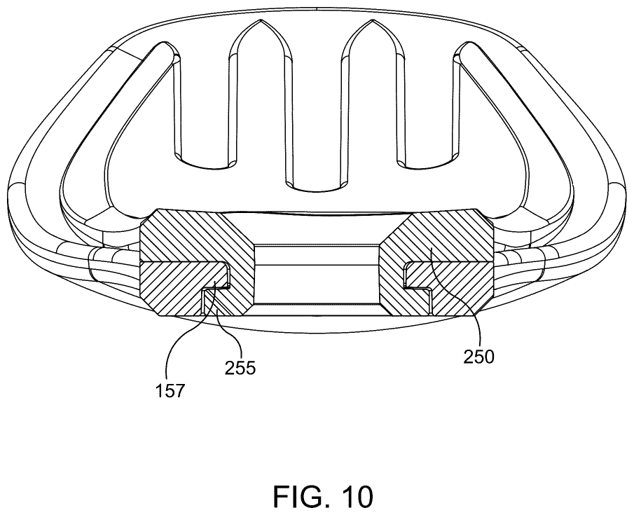

The present invention relates generally to eating utensils that can be stored in a compacted form. FIGS. 1-10 illustrate a combination spoon and fork 50 in accordance with one representative embodiment.

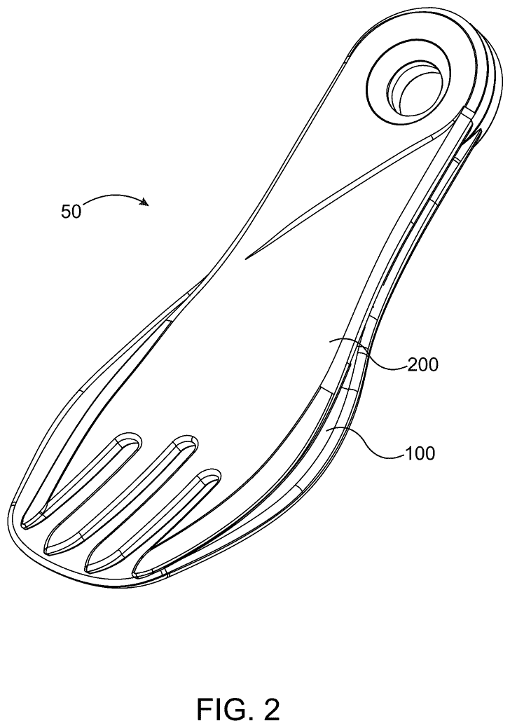

The combination spoon and fork 50 illustrated in FIGS. 1 and 2 includes a spoon component 100 and a fork component 200. The spoon and fork are rotationally coupled together at the proximal ends of their respective handles by a rotational joint 60 such that the fork and spoon can be rotated relative to one another between an extended position suitable for use and a compact nested position, suitable for storage. FIG. 1 illustrates the utensil in the extended position while FIG. 2 illustrates the utensil in the nested position.

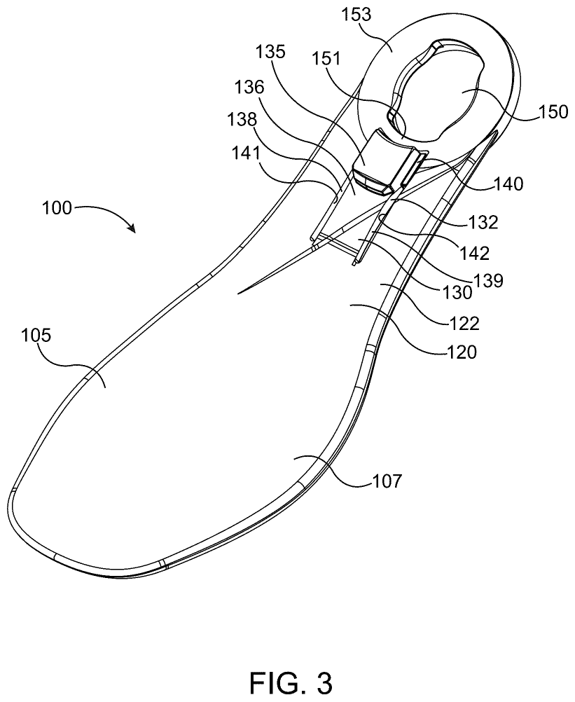

As better seen in FIGS. 3-5, the spoon 100 has a spoon head 105 and a handle 120 that is integrally formed with the spoon head. The spoon head includes a spoon bowl portion 107. The handle 120 includes a cantilevered spring arm 130, a lever opening 132 and a post opening 150. The post opening 150 is located near the proximal end of the spoon handle 120. The lever open 132 is located between the post opening 150 and the spoon head 105 with a relatively narrow bridge 151 separating the post opening 150 from the lever opening 132.

The spring arm 130 is generally positioned within the lever opening 132. A raised pad 135 is provided on the top surface 136 of the free (distal) end of the spring arm 130. A pair of ears 140 are provided on opposing lateral sides of the spring arm at or near the distal end of the spring arm. When viewed from the top, the spring arm 130 fills the majority of the lever opening 132 to effectively form slots 138, 139 on opposite lateral sides of the spring arm 130 between the spring arm and corresponding side walls 141, 142 respectively of the lever opening 132. As will be explained in more detail below, the ears 140 are designed to extend laterally outward from the spring arm 130 to nearly engage the respective side walls 141, 142 within very close tolerances. A small gap 144 separates the distal end of spring arm 130 from bridge 151.

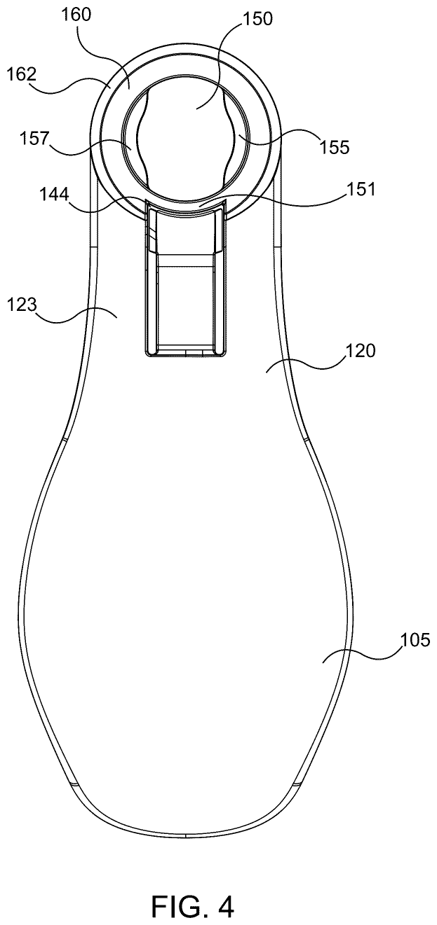

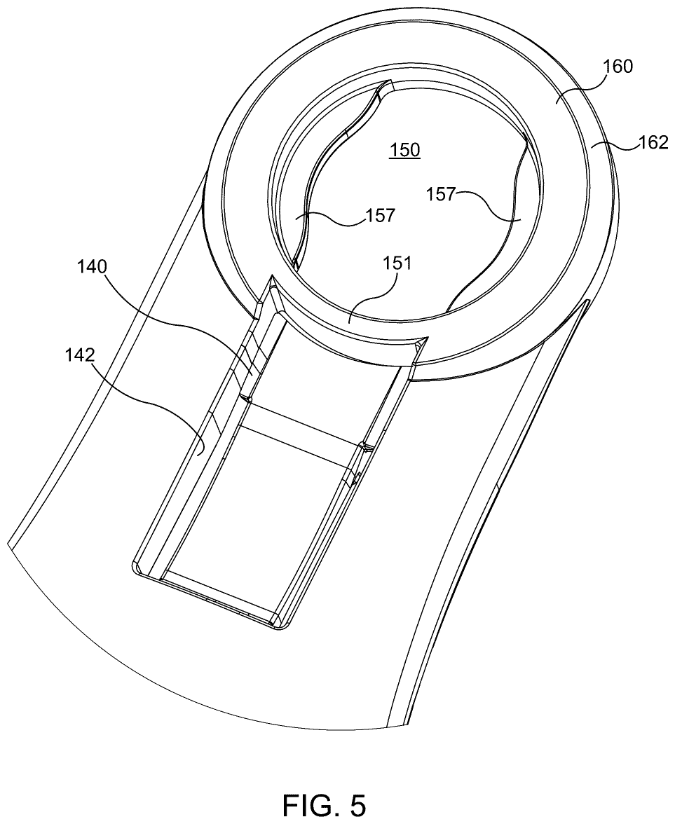

When viewed from the bottom (FIGS. 4 and 5), the post opening 150 is circular, but flanges 155, 157 extend into the top portion of the opening on opposite lateral sides of the post opening. In the illustrated embodiment, the top surface of flanges 155, 157 are co-planar with the top surface 122 of handle 120. Thus, when viewed from the top (FIG. 3), the post opening has a keyed appearance. An annular raised boss 160 encircles the post opening 150 on the bottom surface 123 of the handle. Outer edge of the raised boss 160 is tapered (taper 162) to provide a smooth transition from the adjacent surfaces. The lever opening 120 extends into the boss 160 and the end is arcuate concentric with post opening 150. Thus, the bridge 151 is formed in a region of the boss, which provides additional strength to the bridge.

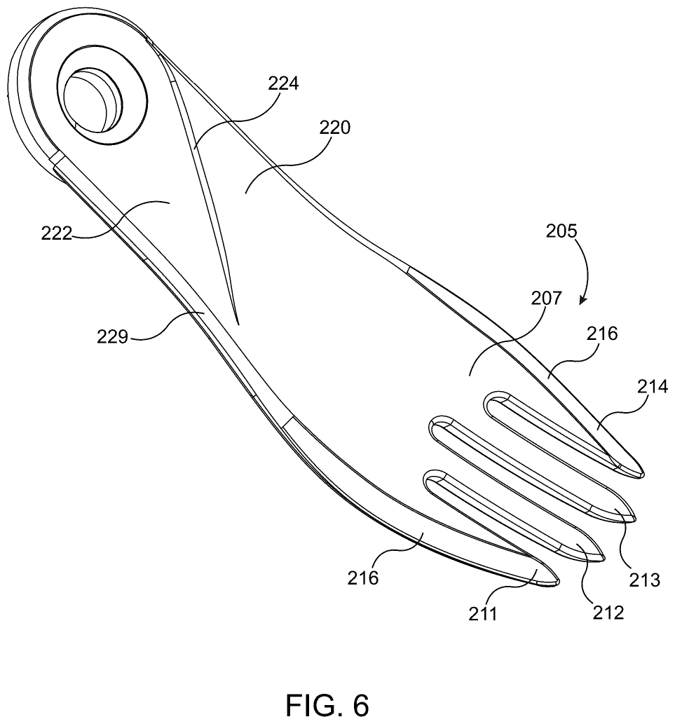

Turning next to FIGS. 6-8, the fork 200 includes a fork head 205 and a fork handle 220 that is integrally formed with the fork head. The fork head includes a concave bowl portion 207 that faces the same way as the concave spoon bowl 107. That is, the concave fork bowl faces (curves) upward when the utensil is in a position with the concave spoon bowl facing upward. The fork head 205 includes a plurality of tines 211, 212, 213 and 214. The upper side edges of the fork head along both the outer tines 211, 214 and the side edges of the fork bowl portion are chamfered (tapered) (chamfers 216) much like the design in U.S. Pat. No. 10,555,629 which is incorporated herein by reference.

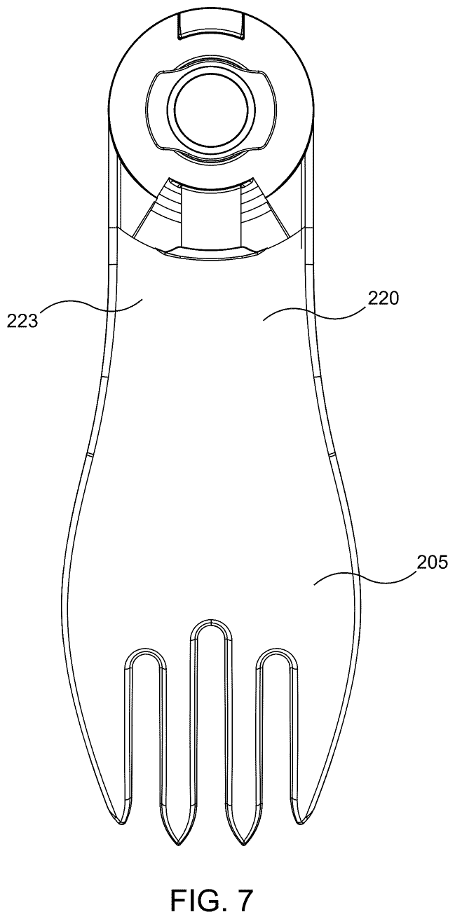

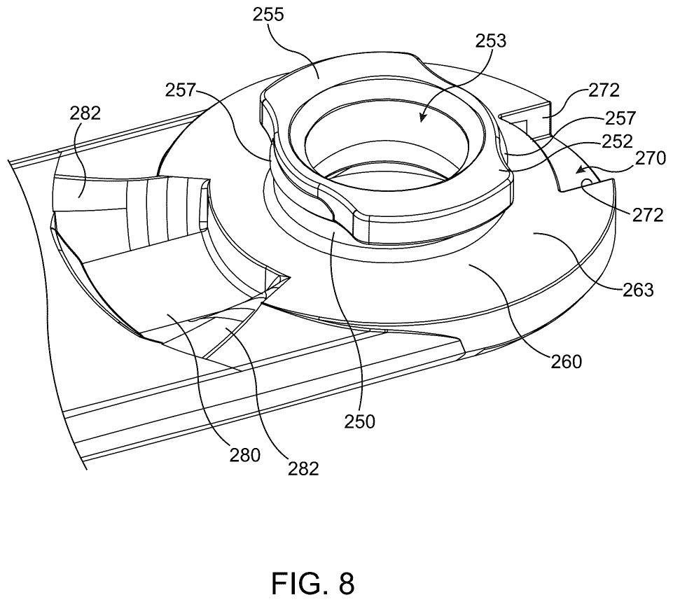

The fork handle 220 has a tubular post 250 that protrudes from the bottom surface 223 of the handle near the proximal end of the handle. The post is best seen in the perspective view of FIG. 8 in conjunction with the bottom view of FIG. 7. The post 250 has an annular, ring-shaped base 252, and one or more, preferably a pair of, laterally extending wings 255 that extend outward from the base 252 such that they overhang. In the illustrated embodiment, the peripheral geometry of the footprint of the post/wings matches the geometry of post opening 150 in the spoon handle so that the fork post can be inserted into the spoon's post opening 150 when the axes of the post opening 150 and tubular post 250 are co-linear. In the illustrated embodiment, that occurs when longitudinal axes of the spoon and fork are aligned perpendicularly to one another. One or more small nubs 257 are provided on an outer wall of the post between the wings. The nubs 257 are intended to provide an interference fit with the flanges 157 of the spoon when the post 250 is inserted into the post opening 150 so that the post can snap into and snap out of the post opening.

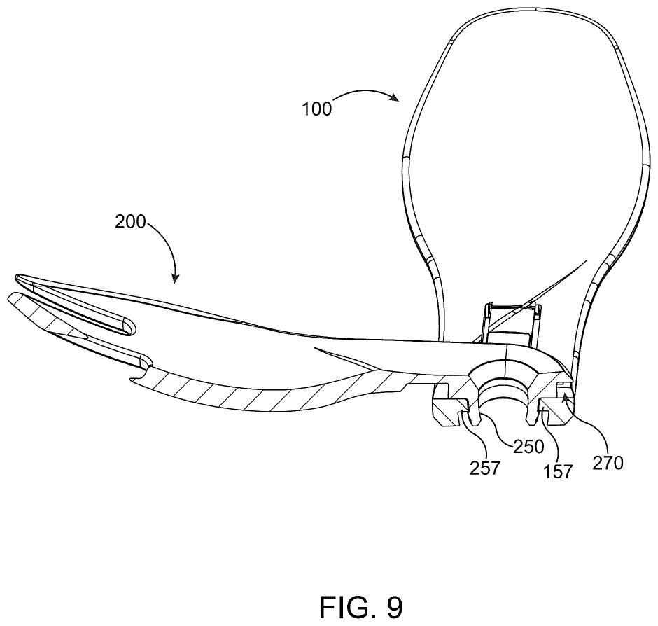

The wings 255 are vertically spaced apart from a base region 260 of the handle by a distance that is just slightly wider than the vertical height of the spoon flanges 157. With this arrangement, the fork post 250 can be snapped into the spoon opening 150 with the spoon and fork extending perpendicularly to one another in a release position as seen in FIG. 9. When snapped together, the base region 260 of the fork is in contact with the top surface of the spoon handle surrounding the post opening 150. These surfaces serve as sliding surfaces 263, 153. Thus, once inserted, the spoon and fork handles can be rotated relative to one another with the centerline of post 250 serving as the center of rotation and the sliding surface 153 on the top surface of the spoon handle 160 sliding over sliding surface 263 on the bottom surface of the fork handle base region 260. Thus, the spoon and fork may be rotated to either the extended orientation or the nested orientation (shown in FIGS. 1 and 2 respectively), and back and forth between such positions, at the discretion of the user.

Since there is a small interference fit between the fork nubs 257 and the spoon flanges 155 and 157, the spoon and fork will not separate/disengage as they pass the release position(s). The natural momentum of rotating the spoon and fork relative to one another and the somewhat precise orientation requirements of the release position (i.e., the post wings 255 must be properly oriented in the regions between spoon flanges 157) both also help mitigate risks of inadvertent separation of the spoon and fork. In the illustrated embodiment, the wings 257 are symmetrical and the flanges 157 are symmetrical and the post opening 150 is symmetrical. Thus, there are actually two potential release positions. That is the position shown in FIG. 9 and a position rotated 180° from the position shown in FIG. 9. This is advantageous since it allows the user to quickly position the fork and spoon perpendicularly in the release position without having to think about which right/left direction the utensils are oriented in. But it should be appreciated that in other embodiments, the geometry of one or more of these features may be adjusted so that there is only a single or more than two release positions. In the illustrated embodiment, the release position is perpendicular to the extended and nested orientations. This works particularly well since the perpendicular orientation tends to be intuitive to many users and it's also a position that most users can readily attain. However, in other embodiments, the release position(s) can be at a different angle—e.g., at 120-degree intervals. A drawback of using other such angles is that it tends to be harder for users to properly position the utensils at the right release orientation when they desire to separate the utensils.

As best seen in FIG. 8, the fork handle also includes a lock recess 270 and a catch recess 280. The lock recess 270 cooperates with spoon spring arm 130 to releasably lock the utensil in the extended position. The catch recess 280 cooperates with spring arm 130 to catch (but not lock) the utensil in the nested position. The lock recess 270 is exposed on the proximal end of the fork handle and is located proximally of the post 250. The catch recess is located distally of post 250. The longitudinal centerlines of both the lock recess 270 and the catch recess extend along the longitudinal centerline of the fork handle 220. The catch and lock recesses are also both symmetrical about the longitudinal centerline of the fork handle.

The cantilevered spring arm 130 on the spoon handle is biased so that pad 135 extends above the top surface 122 of handle 120 in its natural position. However, spring arm 130 is a flexure so the spring arm can be deflected downward by pressing downward on the pad 135. When the utensil is in any position other than the nested or extended orientations, the sliding surface 263 on fork handle base region 260 will depress the pad 135 and thus the spring arm 130. The width of lock recess 270 is sufficient to relatively closely receive the width of the pad 135. Thus, when the utensil is rotated to the extended position, the biasing of the spring arm will cause the pad 135 to snap into lock recess 270 with a portion of the pad 135 extending outside of the footprint of the fork 200, as seen in FIG. 1. Sidewalls 272 of the lock recess 270 are substantially vertical (perpendicular to the fork's base region sliding surface 263) so when the spring arm pad 135 snaps into place, the sidewalls prevent further rotation of the spoon and fork relative to one another thereby locking the utensil in the extended position. This effectively locks the utensil in the extended position. In this orientation, there is nothing below the spring arm 130. Therefore, a user can disengage the lock by simply pressing down on the exposed portion of pad 135 and rotating the fork and spoon relative to one another.

When locked in the extended position a user holding the spoon end of the handle can apply a substantial lateral force on the fork head (e.g., a force suitable for splitting foods like a pear, cooked potato, or apple) and the engagement between the pad 135 and the relevant lock recess sidewall 272 will prevent the fork from rotating away from extended position. This is a significant advantage of the locking extended orientation design.

Somewhat analogously with the lock recess, the pad 135 on spring arm 130 will snap into the catch recess 280 when the spoon and fork are moved to the nested position. However, unlike the lock recess, side walls 282 of the catch recess 280 are tapered as best seen in FIG. 8. The tapered catch recess side walls serve to securely hold the utensil in the nested orientation against the types of normal jiggling and nudging that may occur when the utensil is in the storage (nested) position. At the same time, the spoon and fork can be readily moved from the nested position by affirmatively rotating the spoon and fork heads apart. Specifically, when an affirmative adequate torque is applied to one of the tools relative to the other, the pad 135 will come into contact with the appropriate tapered sidewall 282, which in turn push against pad 135 thereby causing the spring arm 130 to deflect. As the pad 135 exits the catch recess 280, it presses against sliding surface 263 of base 260 along which it can readily slide until it drops into the lock recess 270. The specific taper angle of side walls 282 may vary, but taper angles in the range of 30° to 60° are generally preferred. In a specific example 450 tapers work well.

Since spring arm 135 is elongated and somewhat flexible, it can potentially flex laterally a bit within the slots 138, 139 formed on opposite lateral sides of the spring arm 130 between the spring arm and corresponding side walls 141, 142 respectively of the lever opening 132 when the utensil is in the extended position. Such “play” tends to detract from the feel of the utensil during use, particularly when the splitting feature of the fork head is used, and is therefore generally undesirable. The spring arms ears 140 help mitigate such play because they extend substantially the entire width of their corresponding slots and therefore engage the corresponding side wall if/when lateral force is applied to either of the utensil heads thereby mitigating/substantially eliminating play due to lateral movement of the spring arm.

In the illustrated embodiment, the fork post 250 has a central bore 253 that aligns with the center of the post opening. The origin of the central bore 253 serves as the pivot point about which the fork and spoon rotate relative to one another. The central bore is sized suitably for receiving a fastener such as a carabiner, a tether, a key clip or other suitable fastener that can be used to conveniently carry the utensil, particularly when the utensil is in the nested/storage position. In some embodiments, the top surface 222 of fork handle 220 has a bevel 254 around the central bore that has the appearance of funneling into the bore. The bevel 254 makes it easier to insert a fastener into the central bore and provides a smooth aesthetic appearance.

The spoon and fork handles may have other functional and/or ornamental features as well. For example, in the illustrated embodiment, a diagonal ridge 224 extends across the top surface of the fork handle between a point approximately where chamfer 216 on the right side of the fork head meets handle 222 to a point on the left side of the handle where the main body of the fork handle meets base region 260. The diagonal ridge helps facilitate a better grip on the handle, helps stiffen the handle 220, and provides a nice aesthetic appearance. A similar diagonal ridge can be provided on the spoon handle.

In some embodiments, a handle chamfer 229 extends around the out periphery of the handle. In some embodiments, handle chamfer smoothly merges into the splitter chamfers on opposite sides of the fork head. The handle chamfer helps provide a sleek overall appearance.

The spoon 100 and fork 200 may be formed from a wide variety of different materials. By way of example, BPA-free glass-reinforced thermoplastics such as glass-filled Nylon work well. In other embodiments, the utensil may be formed from polypropylene or other plastics including recycled plastics such as recycled polypropylene, bio-based, or compostable-polymers.

Preferably the spoon 100 and the fork 200 are each molded as single unitary structures. That is, the spoon 100 is molded as a single unitary structure, and the fork 200 is molded as a single unitary structure. One challenge in molding spoon 100 is forming the spring arm ears 140. A simple approach would be to simply provide a mold wall between the ears and the adjacent side was as is normally done in molded parts. However, since the goal is to make the width between the outer edges of the ears identical, or at least substantially identical in width to the width of lever opening 132, providing such a mold wall often results in a larger gap than desired. To mitigate this problem, the lever arm can be molded such that the pad 135 and its ears 140 actually extend above the top surface 122 of the spoon handle within the mold. This both (a) provides an upward bias in the spring arm that is helpful in getting the pad 135 to snap into the lock recess 270 and the catch recess 280; and (b) allows the width between the outer edges of the spring arm ears 140 to be molded at a width that the same or substantially the same as the width of the lever opening 132.

In the illustrated embodiment, the utensil 50 is a combination spoon and fork. The fork head 205 is a bit smaller than the spoon head 105 so that in the nested orientation, the fork head does not extend beyond the periphery of the spoon head in any direction. That is, the footprint of the fork head falls entirely within the peripheral boundary of the spoon head. Such an arrangement provides a nice compact profile while allowing the spoon to have a relatively deep spoon bowl portion. This arrangement also prevents the fork tines from catching on items when being placed into a bag or other storage.

Although only a few embodiments of the invention have been described in detail, it should be appreciated that the invention may be implemented in many other forms without departing from the spirit or scope of the invention. In some embodiments the relative positioning of the spoon and fork heads may be reversed, e.g., the spoon head may overlie the fork head rather than vice versa. In other embodiments, other types of utensil heads may be substituted for one or both of the illustrated heads. For example: (a) two heads of the same type (e.g., two spoon heads or two fork heads) can be provided; (b) a knife head can be used as one of the utensil heads; (c) a spork head (e.g. a head having a spoon bowl together with short tines) may be used as one of the utensil head; or (d) other suitable utensil heads or combinations can be used. In still other embodiments, the same structures rotational coupling structures can be used to make expandable utensils by replacing one of the utensils with a simple handle rather than providing a two headed utensil. For example, a collapsible spoon can be provided by coupling a spoon component to a handle component using the described coupling structures. Of course, collapsible knives, forks, sporks and other utensils may be created using the same coupling structures. Therefore, the present embodiments should be considered illustrative and not restrictive and the invention is not to be limited to the details given herein, but may be modified within the scope and equivalents of the appended claims.

What is claimed is:

1. A utensil comprising:
a first utensil component including a first utensil head and a first handle segment integrally formed with the first utensil head;
a second utensil component including a second utensil head and a second handle segment integrally formed with the second utensil head; and
a releasable coupling configured for rotationally coupling the first handle segment to the second handle segment such that the first and second handle segments can be rotated relative to one another about a pivot axis between distinct nested and extended orientations, wherein in the nested orientation, the first and second utensil heads are nested together with the first and second handle segments aligned longitudinally and stacked, and in the extended orientation the first and second handle elements are aligned longitudinally with the first and second utensil heads located on opposite ends of the utensil; and
wherein the releasable coupling is configured such that the first and second utensil components are held together and are not releasable when oriented in the extended position and when oriented in the nested position; and
the releasable coupling is further configured such that the first and second utensil components can be separated when the first and second utensil components are oriented in a release orientation that is rotationally between the nested and extended positions, there being at least one such release orientation.

2. A utensil as recited in claim 1 further comprising:
a releasable lock configured to lock the first and second utensil components in the extended position when the first and second utensil components are oriented in the extended position; and
a catch feature configured to help hold the first and second utensil components in the nested position when the first and second utensil components are oriented in the nested position.

3. A utensil as recited in claim 1 wherein the release orientation is an orientation in which a longitudinal axis of the first handle segment is substantially perpendicular to a longitudinal axis of the second handle segment.

4. A utensil as recited in claim 1 wherein the releasable coupling allows the first and second utensil components to be rotated 360 degrees relative to one another about the pivot axis and the releasable coupling is configured such that the first and second utensil components can be separated when the first and second utensil components are oriented in two distinct release orientations, wherein in both of the two distinct release orientations, the longitudinal axis of first handle segment is substantially perpendicular to the longitudinal axis of the second handle segment.

5. A utensil as recited in claim 2 wherein:
the lock mechanism includes a cantilever spring integrally formed with the first handle segment of the first utensil component, the cantilever spring including a spring arm and a raised pad, the raised pad configured to snap into a first recess on the second handle segment when the first and second utensil components are rotated to the extended orientation to help lock the first and second utensil components in the extended orientation; and
the lock can be released by pressing on the pad and rotating the first and second utensil components relative to one another.

6. A utensil as recited in claim 5 wherein:
the raised pad is configured to engage a second recess on the second utensil component when the first and second utensil components are in the nested position to help hold the first and second utensil components in the nested position; and
the catch mechanism is or includes the second recess.

7. A utensil as recited in claim 6 wherein side walls of the second recess are tapered so that rotation of the first and second utensil components relative to one another about the pivot axis from the nested position depresses and loads the cantilever spring.

8. A utensil as recited in claim 5 wherein the first recess has a pair of substantially perpendicular side walls that form stops that help prevent relative rotation between the first and second utensil components when the utensil is locked in the extended position.

9. A utensil as recited in claim 5 further comprising a spring opening in the first handle segment having opening walls, and wherein:
the cantilevered spring is positioned to be received within the spring opening; and
the cantilevered spring includes a pair of spring ears extending outward from opposite side edges of the lever arm at or near a free end of the lever arm such that a lateral width of the cantilevered spring between opposite spring ears is wider than a lateral width of the spring arm and wider than a lateral width of the pad, the ears being closely received within the spring opening and configured to limit looseness of the locking mechanism due to lateral flexibility of the spring arm.

10. A utensil as recited in claim 1 wherein the releasable coupling includes:
a post on the second handle segment, the post including a pair of overhanging lobes;
a post opening in the first handle segment configured to tightly receive the post including the lobes when the first and second utensil components are oriented in one of the one or more release orientations to facilitate attachment and separation of the first and second utensil components; and
a pair of recessed ledges on the first handle segment adjacent the post opening, wherein the post lobes are configured to pass on an opposite side of the ledges as a main body portion of the second handle segment as the first and second utensil components are rotated away from the release orientation toward the nested or extended orientation; and
whereby the ledges and the lobes cooperate to prevent the first and second utensil components from separating when the first and second utensil components are not in one of the at least one release orientations.

11. A utensil as recited in claim 10 wherein the post does not protrude beyond a back surface of the first handle segment when first and second handle components are coupled together via the post.

12. A utensil as recited in claim 10 wherein the post has a central bore structured to receive to facilitate attaching the utensil to an external structure or hanging the utensil on the external structure.

13. A utensil as recited in claim 1 wherein one of the utensil heads is a spoon head and the other of the utensil heads is a fork head.

14. A utensil as recited in claim 13 wherein the fork head has a fork bowl portion that is configured to nest with a spoon bowl portion of the spoon head.

15. A utensil as recited in claim 13 wherein in the nested position, the fork head is nested over the spoon head and does not extend outside of a footprint of the spoon head.

16. A utensil as recited in claim 1 wherein one of the utensil heads is a fork head having a plurality of tines including a pair of outer tines and at least one inner tine, and wherein at least one of the outer tines is a splitter tine having a chamfer that facilitates splitting food.

17. A utensil as recited in claim 16 wherein:
an edge of an upper surface of the handle segment is chamfered; and
the fork head chamfer merges with the handle segment chamfer.

18. A utensil comprising:
a first utensil component including a first utensil head and a first handle segment integrally formed with the first utensil head;
a second utensil component including a second handle segment; and
a releasable coupling configured for rotationally coupling the first handle segment to the second handle segment such that the first and second handle segments can be rotated relative to one another about a pivot axis between distinct stacked and extended orientations, wherein in the stacked orientation, the first and second handle segments are aligned longitudinally and stacked, and in the extended orientation the first and second handle elements are aligned longitudinally and extend in opposite directions relative to the releasable coupling;
wherein the releasable coupling is configured such that the first and second utensil components are held together and are not releasable when oriented in the extended position and when oriented in the nested position; and
the releasable coupling is further configured such that the first and second utensil components can be separated when the first and second utensil components are oriented in a release orientation that is rotationally between the nested and extended positions, there being at least one such release orientation.

19. A utensil as recited in claim 18 further comprising:
a releasable lock configured to lock the first and second utensil components in the extended position when the first and second utensil components are oriented in the extended position; and
a catch feature configured to help hold the first and second utensil components in the stacked position when the first and second utensil components are oriented in the stacked position.

20. A utensil as recited in claim 18 wherein the first utensil head is selected from the group consisting of a spoon head, a fork head, a spork head and a knife head and the second utensil component is a handle extension.

21. A utensil as recited in claim 18 wherein:
the second utensil component further includes a second utensil head and the second handle segment is integrally formed with the second utensil head; and
the first and second utensil heads are selected from the group consisting of a spoon head, a fork head, a spork head and a knife head.

22. A utensil comprising:
a first utensil component including a first utensil head and a first handle segment integrally formed with the first utensil head;
a second utensil component including a second handle segment;
a coupling configured for rotationally coupling the first handle segment to the second handle segment such that the first and second handle segments can be rotated relative to one another about a pivot axis between distinct stacked and extended orientations, wherein in the stacked orientation, the first and second handle segments are aligned longitudinally and stacked, and in the extended orientation the first and second handle elements are aligned longitudinally and extend in opposite directions relative to the coupling;
a releasable lock configured to lock the first and second utensil components in the extended position when the first and second utensil components are oriented in the extended position; and
a catch feature configured to help hold the first and second utensil components in the stacked position when the first and second utensil components are oriented in the stacked position.

23. A utensil as recited in claim 22 wherein:
the second utensil component further includes a second utensil head that is integrally formed with the second handle segment; and
the first and second utensil heads are selected from the group consisting of a spoon head, a fork head, a spork head and a knife head.

24. A utensil as recited in claim 22 wherein the first utensil head is selected from the group consisting of a spoon head, a fork head, a spork head and a knife head and the second utensil component is a handle extension.

25. A utensil as recited in claim 22 wherein:
the first utensil head is a spoon head; and
the second utensil component includes a fork head that is integrally formed with the second handle segment.

26. A combination spoon and fork utensil comprising:
a fork including a fork head and a fork handle integrally formed with the fork head;
a spoon including a spoon head and a spoon handle integrally formed with the spoon head;
a releasable coupling configured for rotationally coupling the fork handle to the spoon handle such that the fork and spoon can be rotated relative to one another about a pivot axis between distinct nested and extended orientations, wherein in the nested orientation, the fork and spoon heads are nested together with the fork and spoon handles aligned longitudinally and stacked, and in the extended orientation the fork and spoon handles are aligned longitudinally with the fork and spoon heads located on opposite ends of the utensil;
a releasable lock configured to lock the fork and spoon in the extended position when the fork and spoon are oriented in the extended position; and
a catch feature configured to help hold the fork and spoon in the nested position when the fork and spoon are oriented in the nested position; and
wherein the releasable coupling is configured such that the fork and spoon are held together and are not releasable when oriented in the extended position and when oriented in the nested position; and
the releasable coupling is further configured such that the fork and spoon can be separated when the fork and spoon are oriented in a release orientation that is rotationally between the nested and extended positions, there being at least one such release orientation.
